(19) United States
(12) Patent Application Publication
(10) Pub. No.: US 2010/0281874 A1
(43) Pub. Date: Nov. 11, 2010

(54) Airflow vectoring member

(75) Inventor: Edward Claude Rice, Indianapolis, IN (US)

Correspondence Address: KRIEG DEVAULT LLP, ONE INDIANA SQUARE, SUITE 2800, INDIANAPOLIS, IN, 46204-2079, US

(73) Assignee: Rolls-Royce Corporation

(21) Appl. No.: 12/006,981

(22) Filed: Jan. 8, 2008

Related U.S. Application Data
(60) Provisional application No. 60/879,447, filed on Jan. 9, 2007.

(51) Int. Cl. F02K 1/00

(52) U.S. Cl. 60/770

(57) ABSTRACT

One embodiment is an apparatus comprising an aircraft airflow duct, and a rotatable member disposed within the duct. The rotatable member is rotatable to vector airflow and is capable of being spun in different directions at a variety of rotational rates. Some embodiments include stationary rotatable members.

### CROSS-REFERENCE TO RELATED APPLICATIONS

The present application claims the benefit of U.S. Patent Application No. 60/879,447 filed Jan. 9, 2007, which is incorporated herein by reference.

### TECHNICAL FIELD

The present invention relates to vectoring airflow in an aircraft airflow duct.

### BACKGROUND

Present attempts at vectoring airflow in aircraft airflow ducts suffer from a number of limitations, drawbacks and difficulties including, for example, those respecting weight, complexity, number of components, cost, assembly, installation, maintenance, failure rates, power plant performance, aircraft stability, and others. There is a need for unique and inventive approaches to vectoring airflow in an aircraft airflow duct.

### SUMMARY

One embodiment is an apparatus comprising an aircraft airflow duct, and a rotatable member disposed within the duct. The rotatable member is rotatable to vector airflow. Further embodiments, forms, objects, features, advantages, aspects, embodiments and benefits shall become apparent from the following descriptions, drawings, and claims.

### BRIEF DESCRIPTION OF THE DRAWINGS

FIG. 1 is a side schematic view of an exemplary aircraft airflow duct.

FIG. 2 is a perspective view of an exemplary roller.

FIG. 3 is a perspective view of an exemplary aircraft airflow duct in a first position and in a second position.

FIG. 4 is a perspective view of an aircraft including an exemplary aircraft airflow duct.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated embodiments, and such further applications of the principles of the invention as illustrated therein being contemplated as would occur to one skilled in the art to which the invention relates.

One aspect of the present application includes a rotatable airflow member that is disposed within an aircraft duct and is oriented transverse to a flow stream flowing through the duct. The airflow member is rotated or spun to influence the flow stream downstream of the airflow member. Forces are generated on either the duct or the airflow member as a result of the flow stream and the spinning airflow member. The airflow member is cylindrical in shape and includes an electric motor that provides rotation of the member. Multiple airflow members may be disposed within the duct in some embodiments. A vane may be disposed near the airflow member to further influence the flow stream.

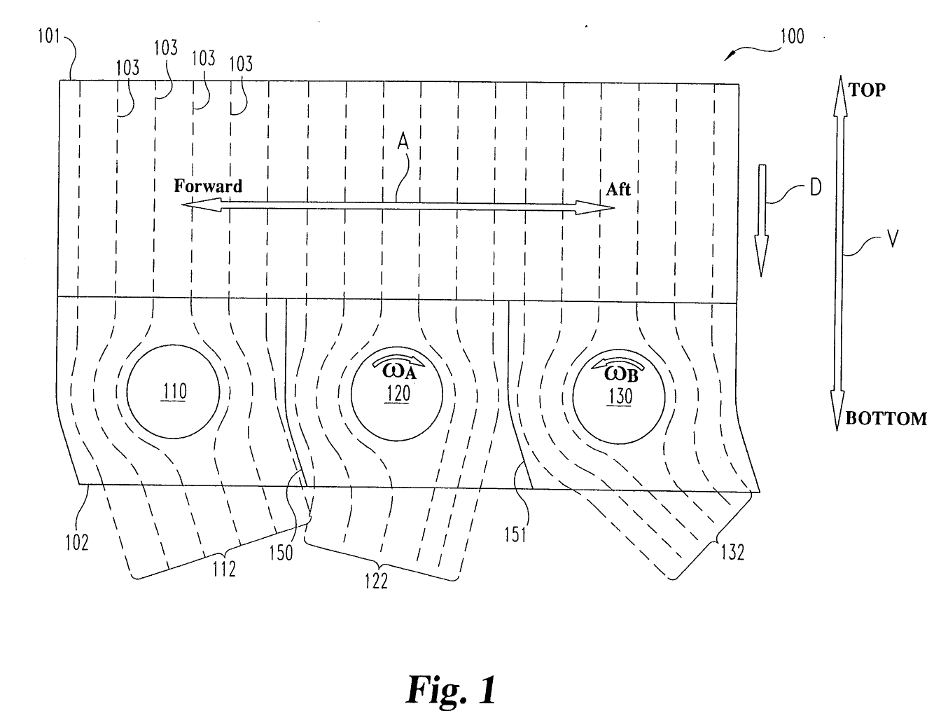

With reference to FIG. 1 there is illustrated an aircraft airflow duct 100 which includes an inlet end 101 and an outlet end 102. In the illustrated embodiment, airflow flows through aircraft airflow duct 100 in a generally downward direction relative to an aircraft (not shown) as indicated by arrow D. The airflow is represented by streamlines 103 in the illustrated embodiment and may sometimes be referred to as a flow field. The airflow is provided by a source not depicted in the illustrated embodiment but may be the exhaust flow from a gas turbine engine or may be the airflow from a fan driven by the gas turbine engine, such as a lift fan, or other suitable device, to set forth just a few nonlimiting examples. The flow field 103 is uniform in speed in the illustrated embodiment but may also be variable across the width and/or length of the duct 100. For purposes of reference only, the fore and aft directions of the aircraft are indicated by the ends of arrow A labeled “Forward” and “Aft.” Additionally, the vertical direction of the aircraft is indicated by the ends of arrow V labeled “Top” and “Bottom”. Though not depicted in FIG. 1, lateral directions of the aircraft are at right angles to both the fore and aft directions and vertical directions, as will be appreciated by those of skill in the art. It will also be appreciated that the directions illustrated herein are arbitrary only and that certain components of the airflow duct 100 may be arranged differently in other embodiments. For example, the airflow duct 100 may be arranged such that the inlet end 101 and outlet end 102 are arranged along the fore and aft directions.

In the illustrated embodiment airflow from airflow duct 100 provides generally downward thrust which can be used to allow the aircraft to hover, for vertical take off and landing (“VTOL”), for short take off and landing (“STOL”) or for other purposes. Additional embodiments contemplate aircraft airflow ducts having airflow in other directions relative to an aircraft. One embodiment contemplates an aircraft airflow duct configured so that airflow flows toward the aft of the aircraft and provides thrust in a generally forward direction. Another embodiment contemplates an aircraft airflow duct configured so that airflow flows toward the front of the aircraft and provides thrust in a generally reverse direction. A further embodiment contemplates an aircraft airflow duct configured so that airflow flows toward a side of the aircraft and provides thrust in a generally sideways direction. Yet another embodiment contemplates an aircraft airflow duct configured so that airflow flows out of a roll post used for a hovering aircraft. Another embodiment contemplates an aircraft airflow duct configured so that airflow flows out of the bottom of the aircraft to provide a vertical lift force. Further embodiments contemplate aircraft airflow ducts configured so that airflow flows in other directions and provides thrust in other general directions. Additional embodiments contemplate positionable airflow ducts which provide airflow in selectable directions. In each of the foregoing embodiments, the aircraft airflow duct preferably includes at least one rotatable member such as a roller for selectably vectoring airflow.

With continued reference to FIG. 1, there are illustrated rollers 110, 120 and 130 which are positioned in aircraft airflow duct 100. The airflow duct 100 may have a variety of cross sectional shapes and dimensions in other embodiments. Though three rollers are illustrated in FIG. 1, other embodiments may have any number of rollers, including a single roller. The rollers 110, 120, and 130 are elongate and are capable of being spun in different directions at a variety of rotational rates and may be positioned at any arbitrary angle. In some embodiments the rollers 110, 120, and 130 may only be capable of rotation in a single direction. The rollers 110, 120, and 130 are depicted as cylindrical in shape but may have other cross sectional shapes as well. Furthermore, the radius of the cylindrical shape may vary along the length of the rollers 110, 120, and 130. In the illustrated embodiment, rollers 110, 120 and 130 are positioned in a line toward outlet end 102 of aircraft airflow duct 100, however, additional embodiments contemplate that rollers 110, 120, and/or 130 could be positioned at different locations. For example, the rollers 110, 120, and 130 may be staggered or otherwise arbitrarily spaced within the airflow duct 100. The axis of rotation of rollers 110, 120, and 130 are parallel, but other embodiments include axes of rotations that may not be parallel. Furthermore, portions of the rollers 110, 120, or 130 may be placed outside of an established flow field and into a boundary layer that forms on a static surface such as the airflow duct 100.

Vane 150 is positioned intermediate roller 110 and roller 120, and vane 151 is positioned intermediate roller 120 and roller 130. Vanes 150 and 151 are static vanes, but could be adjustable vanes in other embodiments. Some embodiments may also include vanes on either end of rollers 110 and 130, which vanes may or may not be incorporated into the airflow duct 100.

FIG. 1 depicts one operational configuration of the system wherein roller 110 is stationary, roller 120 rotates in a clockwise direction as indicated by arrow ω_{A}, and roller 130 rotates in a counterclockwise direction as indicated by arrow ω_{B}. Roller 110 may be held stationary by any suitable mechanism, including a brake or pin, or may be stationary as a result of internal friction that acts counter to any external forces or moments. Other rollers may also include suitable mechanisms, such as brakes or pins for example, to remain stationary. Since roller 110 is stationary, it does not vector airflow, and airflow past roller 110 proceeds in a neutral direction as indicted by brace 112. In the illustrated embodiment, the neutral direction is determined by aircraft airflow duct 100 and vane 150, and is generally downward and slightly toward the aft of the aircraft. Other neutral positions may be provided by varying the geometry and directions of aircraft airflow duct 100 and/or vane 150 and/or through the presence of other structure(s). Due to the clockwise rotation of roller 120, airflow past roller 120 is vectored toward the fore of the aircraft as indicated by brace 122 which provides thrust in the aft direction. Due to the counterclockwise rotation of roller 130, airflow past roller 130 is vectored toward the aft of the aircraft as indicated by brace 132 which provides thrust in the forward direction. The direction and rate of rotation of each of rollers 110, 120 and 130 is independently controllable. Thus, rollers 110, 120 and 130 can vector airflow in the same or different directions as one another and to the same or varying degrees. Preferably, vectoring of airflow by rollers 110, 120 and/or 130 is a result of the Magnus effect, however, it is contemplated that any principle of operation which results in vectoring of airflow could be used. In certain embodiments, two or more rollers can be independently controlled to provide a gyroscopic effect giving a more stable platform for the aircraft. In certain embodiments, additional vertical thrust elements, such as roll posts, can be employed and the amount of power plant bleed air required to provide stability to the aircraft platform can be reduced. In operation, any of the rollers that are free to rotate can be rotated at any given rotational rate. Furthermore, the rollers 110, 120, and/or 130 may be rotated from one angular position to another at an arbitrary rate that may be constant or may be time varying.

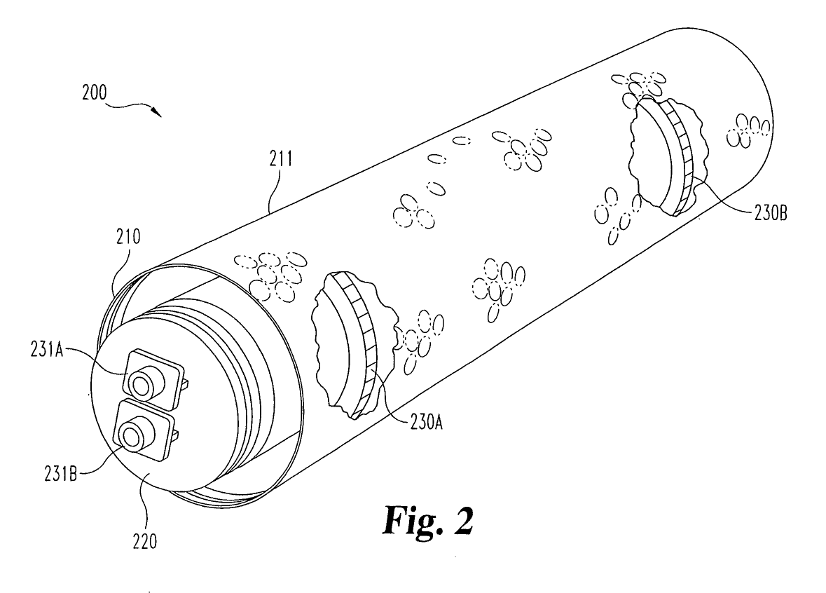

With reference to FIG. 2, there is illustrated an exemplary roller 200 which is adapted to be positioned in aircraft airflow duct such as aircraft airflow duct 100 of FIG. 1. Roller 200 includes an outer rotatable member 210 provided about a static support member 220. Static support member 220 is adapted to be coupled with an aircraft airflow duct, for example, with one or more fasteners or by other means. In the illustrated embodiment, outer rotatable member 210 is substantially cylindrical and has a substantially circular cross-sectional shape, however, it is contemplated that rotatable members having a variety of other shapes could be utilized. Outer rotatable member 210 is also illustrated with a dimpled surface exterior surface 211 which enhances vectoring of the wake downstream from rotatable member 210 when airflow passes it as it rotates. The dimpling may extend along the entire exposed length of the roller or portions thereof. In addition, dimpling may be in sections or in strips or any other arrangement. Other embodiments contemplate a variety of other textured, exterior surfaces, for example, smooth, ridged, grooved, roughened, and other surfaces could be used. Some embodiments of roller 200 may even include a variety of textured portions. In the illustrated embodiment, static support member 220 is a substantially cylindrical support shaft, however, it is contemplated that a variety of other support members could be used.

As illustrated in the cutaway portions of FIG. 2, electric motors 230A and 230B are supported by static support member 220 within outer rotatable member 210. Though two electric motors 230A and 230B are depicted, some embodiments may include only one motor while others may include multiple motors. Electric motors 230A and 230B are coupled to outer rotatable member 210 and can selectably cause it to rotate in a clockwise or counterclockwise direction at a selectable rate. Some motors may be configured to rotate in a single direction only. Preferably electric motors 230A and 230B are each capable of driving rotatable member 210 and provide dual redundant drive. Electric motors 230A and 230B are coupled to electrical connectors 231A and 231B which supply power to electric motors 230A and 230B, respectively. The electrical connectors 231A and 231B may be located on either end of the rotatable member 210, or together on the same end as is depicted. Additional embodiments contemplate other means for driving outer rotatable member 210, for example, a drive shaft operatively linked to a gas turbine engine or other drive mechanism.

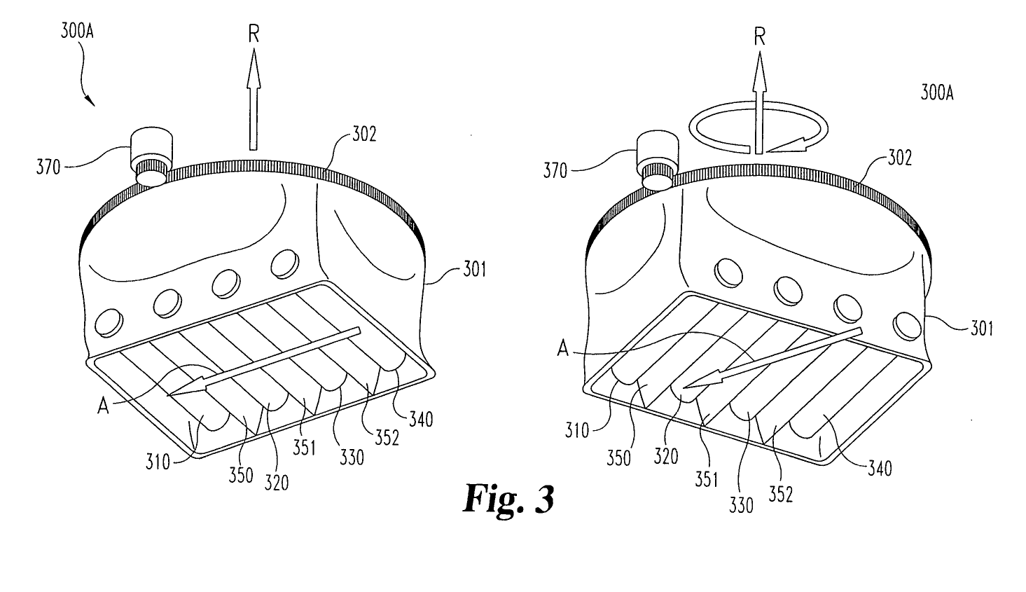

With reference to FIG. 3, there is illustrated an exemplary aircraft airflow duct in a first position 300A and the same aircraft airflow duct in a second position 300B. The aircraft airflow duct includes rollers 310, 320, 330, and 340 which are positioned in duct body 301 and which could be the same as or similar to the rollers described above in connection with FIGS. 1 and 2. The aircraft airflow duct includes vanes 350, 351, and 352 which are positioned in duct body 301 and which could be the same as or similar to the vanes described above in connection with FIGS. 1 and 2.

The aircraft airflow duct is coupled to an aircraft (not shown) the front direction of which is indicated by arrows A. The duct body 301 includes a toothed portion 302 which engages and is driven by gear 370. The toothed portion 302 and gear 370 may be a sprocket gear, bevel gear, or other types of gear arrangements. Gear 370 may be mechanically driven by a shaft coupled to a gas turbine engine and is operable to rotate the duct body 301 around the axis parallel to the airflow in the duct which is indicated by arrow R. Gear 370 may also be driven using other techniques such as a rotary, electrically powered actuator. Other mechanisms may also be used to rotate the duct body 301 about its axis. Some embodiments may provide rotation of the duct body 301 about an axis that is not parallel to the airflow in the duct. The duct configuration in FIG. 3 allows the vectored airflow from rotating cylinders 310, 320, 330, and/or 340 to be selectably directed about the axis of rotation of the duct body 301. Thus, duct body 301 can be rotated from position 300A to position 300B as well as to a variety of other positions. In certain embodiments, the selectably positioning of duct body 301 can provide yaw capability to an aircraft. Forces and moments other than yaw capability may be provided by selectably positioning the duct body 301, depending on the relative orientation of the center of gravity and the duct.

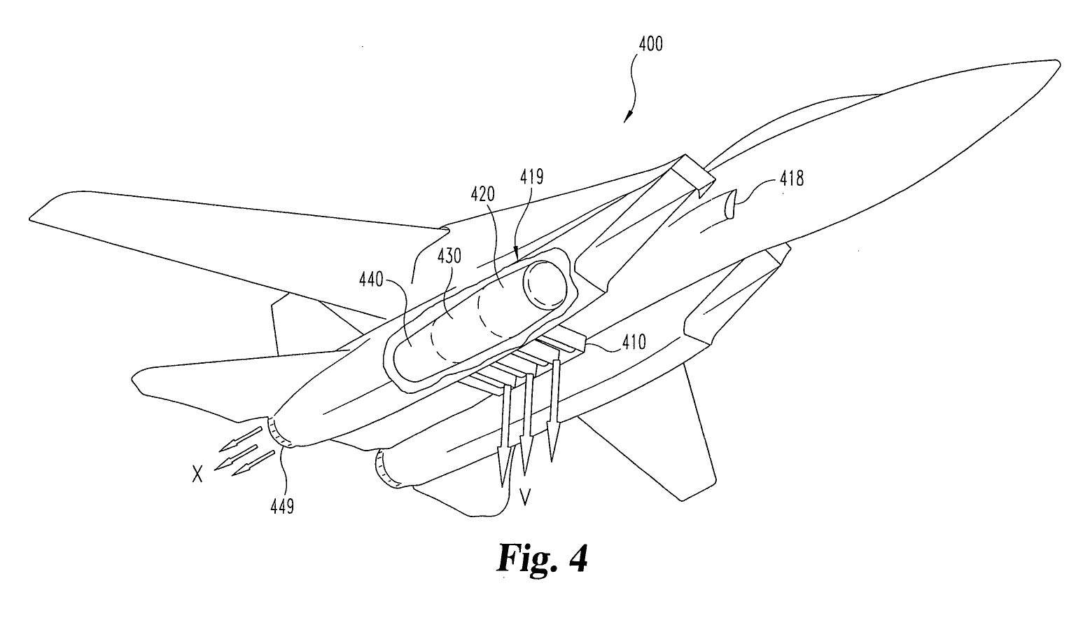

With reference to FIG. 4, there is illustrated an aircraft 400 including an exemplary aircraft airflow duct 410 which could be the same or similar to the aircraft airflow ducts described above. It should be understood that the term “aircraft” as used herein includes helicopters, airplanes, missiles, unmanned space devices, transatmospheric vehicles and other substantially similar devices. Aircraft 400 includes a gas turbine engine 419 which is illustrated as a generalized schematic in the cutaway portion of aircraft 400. Gas turbine engine 419 includes turbomachinery such as a compressor section 420, a combustor section 430, and a turbine section 440 that are integrated together. Gas turbine engine 419 receives air from intake 418 and can provide output through nozzle 449 to provide forward thrust as indicated by arrows X. A portion of the energy from gas turbine engine 419 can be used to selectably provide airflow through aircraft airflow duct 410, for example by driving a fan with a shaft coupled to gas turbine engine 419, by providing compressed air from compressor 420, or through other techniques. Aircraft airflow duct 410 can selectably provide vertical thrust as indicated by arrows V and can vector airflow in a manner the same or similar to that described above.

It is important to realize that there are multitudes of ways in which gas turbine engine components can be linked together. In one form, gas turbine engine components are integrated to produce an aircraft flight propulsion engine generally referred to as a turbo-fan. Another form of a gas turbine engine includes a compressor section, a combustor section, and a turbine section integrated to produce an aircraft flight propulsion engine without a fan section. It should be understood that the present invention is not limited to the embodiments illustrated and described herein. It is also important to realize that there are a multitude of additional components which can be used in gas turbine engines. For example, additional compressor and turbine stages could be present with intercoolers connected between the compressor stages.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A gas turbine engine apparatus comprising:
a duct capable of flowing a flow stream generated by the gas turbine engine; and
an airflow vector member disposed within the duct and capable of rotating through any angle, the airflow vector member includes an outer surface exposed to the flow stream.

2. The apparatus of claim 1 wherein the flow stream is a flow stream produced by the turbomachinery of the gas turbine engine.

3. The apparatus of claim 1 which further includes a lift fan, wherein the gas turbine engine generates energy to power the lift fan, and wherein the lift fan provides the flow stream.

4. The apparatus of claim 1 which further includes a plurality of airflow vector members.

5. The apparatus of claim 4 wherein at least two airflow vector members have rotational axes that are substantially parallel to one another.

5. The apparatus of claim 1 wherein the airflow vector member is cylindrical in shape.

7. The apparatus of claim 1 wherein the airflow vector member is textured.

8. The apparatus of claim 1 wherein the airflow vector member is dimpled.

9. The apparatus of claim 1 wherein the duct is rotatable.

10. The apparatus of claim 1 which further includes:
a plurality of airflow vector members;
wherein the airflow vector members are cylindrical in shape; and
wherein the airflow vector members are textured.

11. An apparatus comprising:
a gas turbine engine capable of generating an airflow;
an airflow vector assembly capable of receiving the airflow;
a spinable member disposed within the airflow vector assembly and capable of vectoring the airflow, the spinable member having an exterior; and
the airflow passes over the exterior of the spinable member.

12. The apparatus of claim 11 wherein the airflow is produced from a fan driven by the gas turbine engine.

13. The apparatus of claim 11 which further includes an electric motor, wherein the spinable member is rotatable by the electric motor.

14. The apparatus of claim 3 wherein the electric motor is disposed within the spinable member.

15. The apparatus of claim 11 which further includes a rotating mechanism coupled to the airflow vector assembly, wherein the rotating mechanism is capable of rotating the airflow vector assembly about an axis.

16. The apparatus of claim 11 wherein the airflow vector assembly is coupled to an aircraft.

17. An apparatus comprising:
an airflow duct capable of flowing an flow stream generated by a gas turbine engine; and
means for vectoring the flow stream disposed within the airflow duct.

18. A method comprising:
passing a flow stream provided by a gas turbine engine through a duct; and
spinning an airflow member within the flow stream.

19. The method of claim 18 which further includes altering a direction of the flow stream downstream of the airflow member.

20. The method of claim 18 which further includes positioning a vane near the airflow member.

21. The method of claim 18 which further includes modulating the spinning of the airflow member.

22. The method of claim 21 wherein the modultating the spinning includes varying the spinning rate or direction of the airflow member.

23. The method of claim 18 which further includes rotating the duct to redirect the flow stream through the duct.
